(19) United States
(12) Patent Application Publication
(10) Pub. No.: US 2023/0241726 A1
(43) Pub. Date: Aug. 3, 2023

(54) HDH (HYDRIDE-DEHYDRIDE) PROCESS FOR FABRICATION OF BRAZE ALLOY POWDERS

(71) Applicant: OERLIKON METCO (US) INC., Westbury, NY (US)

(72) Inventors: Colin Gary McCracken, Bright's Grove (CA); Dongmyoung Lee, Novi, MI (US); Subramamiam Rangaswamy, Rochester Hills, MI (US)

(73) Assignee: OERLIKON METCO (US) INC., Westbury, NY (US)

(21) Appl. No.: 17/927,890

(22) PCT Filed: May 28, 2021
(86) PCT No.: PCT/US2021/034795

§ 371 Date: Nov. 27, 2022

Related U.S. Application Data
(60) Provisional application No. 63/031,835, filed on May 29, 2020.

(51) Int. Cl. B23K 35/32; B22F 1/052; B22F 9/02; B22F 1/065

(52) U.S. Cl. CPC B23K 35/325; B22F 1/052; B22F 9/023; B22F 1/065

(57) ABSTRACT

A method for preparing powders of hard alloys, such as Ti and Ti—Zr alloys, using a hydride-dehydride process, and powders produced by the process, are disclosed. The method can be used to manufacture brazing powders. The method is less hazardous and more cost effective than current methods, such as gas atomization, of preparing such braze materials.

This application claims the benefit of U.S. Provisional Patent Application 63/031,835, filed May 29, 2020, which is incorporated herein by reference in its entirety.

### FIELD OF THE INVENTION

The invention relates to manufacturing methods that include a hydride-dehydride (HDH) process and optional deoxidation process, and to use of the methods to prepare compositions, including brazing compositions.

### BACKGROUND OF THE INVENTION

Brazing can be generally described as subjecting a substrate and a braze material to a temperature that is high enough to cause the braze material to completely melt (i.e., at least the liquidus), but not high enough to melt the substrate. That is, brazing materials should have a low liquidus temperature compared to the melting point of the substrate. The melted braze material flows and can fill in cracks or gaps in the substrate. The substrate generally comprises two or more work pieces, which when cooled, are bonded by the solidified braze material. Accuracy and precision of the brazing process depends on many factors, including the physical and chemical properties of the braze material. Among other things, a braze material in the form of a powder should have a well-defined particle size distribution.

Certain braze materials, such as those based on Ti and Ti—Zr alloys, present special manufacturing considerations because the alloys are extremely hard, which complicates the manufacturing process. Another complicating factor is the high reactivity and affinity for oxygen demonstrated by finely divided (high specific surface area) of fine metal powders, including titanium powders, which render hazardous their manufacture and handling. U.S. Pat. No. 7,559,454 discloses that powder braze materials comprising metals such as titanium are manufactured by the plasma rotating electrode process (PREP), gas atomization (GA), reaction synthesis (RS), or mechanical comminution. Electrode induction gas atomization (EIGA) is also known.

Mechanical comminution cannot be effectively performed on brazing materials that are very hard, such as those having a high content of Ti, Zr, Hf, V, Nb, Y, and/or Ta; and/or that have a high content of refractory metal.

The plasma rotating electrode process is not generally used because it is a very expensive method, even more expensive than gas atomization. PREP also has limitations on particle size distribution, generally producing very little yield below 75 μm.

Historically, titanium-based powder brazing compositions have been prepared on a commercial scale by gas atomization. Gas atomization devices typically consist of an apparatus for liquefying (melting) metal stock, an atomizing gas jet, and a cooling/collecting chamber. An inert cooling gas such as argon is blown on the free-falling stream of molten metal, e.g., titanium, which atomizes and solidifies in flight through the cooling chamber, and particles are collected at the bottom of the chamber.

Gas atomization of titanium and titanium alloys is a hazardous process, and entails a high risk of explosion because of the unstable nature of fine titanium powder. There is additional risk because of the high reactivity of liquefied titanium with equipment (e.g., crucibles) used in the gas atomization process. Moreover, the yield of brazing composition made by gas atomization is low because of the difficulty of controlling the particle size distribution during the spraying process. The large and small particles removed subsequently by sieving cannot be practically recycled or re-used, and are wasted. The strict process and equipment controls that have to be put into place as a result of the hazards of gas atomization, as well as the wasted product inherent in the poor control over particle size distribution, contribute significant cost to the preparation of titanium brazing composition.

Despite these drawbacks, for the past several decades, gas atomization has been the industry-accepted standard for manufacturing brazing compositions having high content of hard metals, such as Ti and alloys of Ti and Ti—Zr.

There is a need for a process for preparing brazing compositions based on hard metals, such as Ti alloys and Ti—Zr alloys, that is safer and less expensive than gas atomization. There is a need for brazing compositions prepared by methods that are safer and less expensive than currently used in the industry, e.g., safer and less expensive than gas atomization.

### SUMMARY OF THE INVENTION

It has been surprisingly discovered that it is possible to prepare brazing compositions based on hard metals such as titanium using a hydride-dehydride process. The method is less expensive and less hazardous than current manufacturing methods, and is expected to be more commercially viable than current manufacturing methods.

In one aspect, there is provided a method for manufacturing a braze powder comprising: obtaining a starting material amenable to HDH process, wherein the starting material is an alloy substantially comprising 55 mol % to 95 mol % HDH metal, and 5 mol % to 45 mol % non-HDH metal; processing the starting material in an HDH process to obtain a processed HDH powder; and sizing the HDH powder to obtain a target particle size distribution to obtain a sized HDH powder; wherein the sized HDH powder is suitable for use as a braze powder.

In another aspect, there is provided method for manufacturing a metal powder comprising: obtaining a starting material amenable to HDH process, wherein the starting material is an alloy substantially comprising 55 mol % to 88 mol % HDH metal, and 12 mol % to 45 mol % non-HDH metal; processing the starting material in an HDH process to obtain a processed HDH powder; and sizing the HDH powder to obtain a target particle size distribution to obtain a sized HDH powder.

In another aspect, there is provided a braze powder prepared by: obtaining a starting material, wherein the starting material is an alloy substantially comprising 55 mol % to 95 mol % HDH metal, and 5 mol % to 45 mol % non-HDH metal; processing the starting material in an HDH process to obtain a processed HDH powder; and sizing the HDH powder to obtain a target particle size distribution to obtain a sized HDH powder; wherein the sized HDH powder is suitable for use as a braze powder.

In another aspect, there is provided a braze powder comprising low interstitial oxygen, and methods of manufacturing thereof. In another aspect, there is provided a manufacturing method which, after processing the starting material in the HDH process, further includes deoxidizing to obtain an HDH powder having 0.25 wt % or less interstitial oxygen. In another aspect, there is provided an HDH powder comprising 0.25 wt % or less interstitial oxygen.

In an aspect, the HDH process comprises: heating the starting material under suitable hydriding conditions to form a hydride-rich material; pulverizing the hydride-rich material; sizing the hydride-rich material to obtain a sized hydride having a target particle size distribution; and heating the sized hydride under suitable dehydriding conditions to decompose metal hydride in the sized hydride to obtain the HDH powder.

In an aspect, the method can comprise sizing the de-hydrided powder to obtain a de-hydrided powder having a second target particle size distribution.

In an aspect, the method can comprise spheroidization of the sized HDH powder.

In an aspect, the starting material can substantially comprise 75 mol % to 95 mol % HDH metal. In an aspect, the HDH metal can comprise, consist essentially of, or consist of, Ti, Zr, Hf, V, Nb, Ta, or a combination of one or more thereof.

In an aspect, the non-HDH metal can comprise, consist essentially of, or consist of, Cu, Ni, W, Sn, Al, Zn, Mo, Cr, Fe, or a combination of one or more thereof.

### BRIEF DESCRIPTION OF THE DRAWINGS

FIG. 1 is a photograph of the BTi-1 crushed powder following hydride formation, and prior to milling, screening, and de-hydriding.

FIG. 2 is a scanning electron micrograph (SEM) (100× magnification) of the product of Example 1 following de-hydriding, re-milling, and screening. The scale bar is 500 μm.

FIG. 3 is an SEM-EDS image of a brazing composition made using the HDH process. The Cu, Ni, and Ti elemental mapping images are shown respectively in FIGS. 3a, 3b, and 3c. The scale bar is 500 μm.

FIG. 4 is an SEM-EDS image of a brazing composition, on a particle-sized scale, made using the HDH process. The Cu, Ni, and Ti elemental mapping images are shown respectively in FIGS. 4a, 4b, and 4c. The scale bar is 100 μm.

FIG. 5 comprises SEM-EDS images of a selected region from a single particle. The Cu, Ni, and Ti elemental mapping images are shown respectively in FIGS. 5a, 5b, and 5c. The scale bar is 25 μm.

FIG. 6 shows front and back views of Ti-6Al-4V coupons brazed with BTi-1 brazing powder manufactured according to the invention (FIGS. 6a and 6b), and conventionally (FIGS. 6c and 6d).

FIG. 7 shows front and back views of coupons brazed with BTi-1 HDH brazing powders having 0.26 wt % interstitial oxygen (FIGS. 7a and 7b) and 0.12 wt % interstitial oxygen (FIGS. 7c and 7d).

### DESCRIPTION OF THE INVENTION

The present invention provides a process for preparing brazing powders using a hydride-dehydride (HDH) process. Generally, the HDH process takes advantage of the properties of certain metals that are very hard and difficult to form into powder, but that have brittle, stable, and reversible hydrides.

As is well understood in the art, the HDH process generally comprises:
1. Providing in a suitable form, such as a casting, a material comprised substantially of HDH metal and/or alloy thereof;
2. Embrittling the material by placing it in a furnace at an elevated temperature and cooling under a partial pressure of hydrogen thus forming the brittle hydride;
3. Pulverizing the brittle hydride by crushing and/or milling to obtain a crushed powder having the appropriate particle size distribution;
4. Placing the crushed powder into a vacuum furnace at an elevated temperature and high vacuum (high enough to de-hydride the composition, but not high enough to melt the composition) to remove the hydrogen, thereby obtaining a metal powder (including an alloy powder).

The HDH process is commonly used to prepare powders of pure Ti (melting point 1649° C.) and of Ti-6Al-4V (melting range 1604°−1660° C.). These powders have melting points at or near the melting point of titanium, which renders them unsuitable as brazing materials for titanium substrates, and other substrates having similar or lower melting points.

For hydriding and dehydriding, any suitable elevated temperatures will do, and can be determined by the person of skill in the art. Hydrides typically form under cooling in a hydrogen partial pressure from temperatures about, or in excess of, 650° C. Under vacuum, hydrides typically decompose at temperatures about, or in excess of, 350° C. The temperature used should be less than the solidus of the alloy since melting of the alloy, and sintering of alloy particles, should be avoided.

As is known in the art, after both the hydride and dehydride cycles, the alloy powder should be passivated under controlled conditions, which can result in an increased overall oxygen and nitrogen content compared to the raw materials. Also during the dehydride operation, the alloy powder particles in the range of <45 um can begin to sinter under the elevated temperature and high vacuum atmosphere. The <45 um powder agglomerates are difficult to re-size, which can limit the PSD that can be achieved using the HDH process.

If deemed prudent for a given application, oxygen content can optionally be reduced after the hydride and/or dehydride cycles. Any method of deoxygenation can be used, and can be determined by the person of ordinary skill of the art. One such method is disclosed in “Manufacture Of HDH Low Oxygen Ti-6Al-4V Powder Incorporating A Novel Powder De-Oxidation Step,” C.G. McCracken, et al., Proceedings of the 2009 International Conference on Powder Metallurgy & Particulate Materials, Pages 146-152, Las Vegas, Nev., USA, which is incorporated herein by reference in its entirety.

As used in the present disclosure, the term “amenable to HDH” or “suitable for HDH” in reference to a material such as a metal or alloy means that the metal or alloy is suitable for the reversible HDH process, even if not so previously recognized. That is, it is possible to embrittle the material by hydriding, to reduce the particle size of the hydride, such as by crushing and milling, to a target PSD, and to de-hydride the material to recover the material in a form having reduced particle size.

Powders obtained from the HDH process have been typically formed into articles of manufacture by any of a number of techniques, such as pneumatic isostatic forging (PIF) or hot isostatic pressing (HIP). Titanium metal and alloys thereof, such as Ti-6-4 (with nominal composition 90 wt % Ti, 6 wt % Al and 4 wt % V), are commonly industrially formed into articles by these processes. Such powders are also routinely used to coat medical devices using thermal spray methods.

However, it is believed that the HDH process has not been used to prepare braze materials, and that the HDH process has not been used on alloys (e.g., T or Ti—Zr based alloys) with lower content of HDH metal. In order to be successful, the HDH process requires a starting material with a high content of an HDH metal, even 100% content, such as pure titanium (aside from trace impurities). If the content of the HDH metal is too low, then the resulting hydride will not be brittle enough to crush or mill effectively. The conventional wisdom and practice in the industry is that a content of HDH metal below about 90 mol % (based on metal atoms) would not be amenable to the HDH process.

By “HDH metal” is meant a hard metal having a brittle hydride, which is amenable to treatment by the HDH process. HDH metals include, but are not limited to, Ti, Zr, Hf, V, Nb, Ta, and combinations thereof. Preferred HDH metals include Ti, Zr, and Hf, more preferably Ti.

By non-HDH metal is meant any metal that is not amenable to the HDH process for any reason, such as not having a brittle hydride, or one that cannot be practically de-hydrided. Non-HDH metals include, but are not limited to, Cu, Ni, W, Sn, Al, Zn, Mo, Cr, and Fe. Some of these metals form stable hydrides that are not reversible, e.g., CuH, SnH₄, AlH₃, ZnH₂, and CrH.

Until now, in compositions intended for an HDH process, non-HDH metals have traditionally been kept to a minimum, e.g., equal to or less than 6 mol %, 8 mol %, 10 mol %, or 12 mol %. It was generally thought that higher amounts of non-HDH metals would render the alloys not amenable to the HDH process.

However, it has been unexpectedly found that alloys comprising much higher contents of non-HDH metals can be processed using the HDH process to provide powders with highly uniform particle size distributions. It has been unexpectedly found that brazing compositions based on such alloys—now unexpectedly discovered to be amenable to the HDH process—can be prepared using the HDH process. The HDH process is much safer than the industry standard gas atomization process. The HDH process is much less expensive than the industry standard gas atomization process. The utility of the relatively safe and inexpensive HDH process is completely unexpected, especially in view of the long history, and acceptance by the industry, of such complicated and expensive methods as gas atomization.

In particular, it has been unexpectedly found that alloys comprising more than 12 mol % non-HDH metal, 25 mol % non-HDH metal, or even as high as 45 mol % non-HDH metal, could be processed with the HDH process, to provide powders with useful properties. For example, such powders could be useful as brazing compositions.

Briefly, the present disclosure provides a process comprising:
A. Providing a material amenable to the HDH process;
B. Hydriding the material to forming the brittle hydride thereof;
C. Pulverizing the brittle hydride, such as by crushing and/or milling;
D. Sizing the pulverized brittle hydride, such as by screening, to obtain a powder having a target particle size distribution;
E. Dehydriding the sized hydride to obtain a metal powder;
F. Optionally de-agglomerating and/or milling the metal powder;
G. Optionally re-sizing the metal powder, such as by re-screening;
H. Optionally deoxidizing the metal powder.

The product of the above process can be used in any suitable manner. In an aspect, the above method is used to prepare a brazing powder, preferably of a composition that is primarily a Ti based alloy or Ti—Zr based alloy.

Any alloy of HDH metal can be evaluated for use as a starting material in accordance with this disclosure, preferably an alloy that can provide a suitable titanium braze powder. Such alloys preferably comprise a major part of HDH metal, and a minor part of non-HDH metal.

The starting material can comprise any amount of HDH metal desired, so long as it is effective within the present disclosure. An amount of HDH metal that is too low will compromise the HDH process by, for example, providing a hydride of insufficient brittleness to effectively pulverize. There is no upper limit to the amount of HDH metal in the starting material, and amounts of 100 mol % or about 100 mol % are contemplated. By “major part of HDH metal” is meant that the composition comprises sufficient HDH metal render the composition suitable for HDH processing. Preferably, HDH metal comprises 95 mol %, or 90 mol %, 89 mol %, 88 mol %, 87 mol %, 86%, 85 mol %. 75 mol %, 65 mol %, or 55 mol %, of the starting material, and/or of the braze powder, as well as ranges formed by any two of these percentages, and all ranges subsumed within any of these ranges.

The starting material can comprise any amount of non-HDH metal desired so long as it is effective within the present disclosure. If the amount of non-HDH metal is too high, it will compromise the HDH process by, for example, providing a hydride of insufficient brittleness to effectively pulverize. There is no lower limit to the amount of non-HDH metal, though a certain amount may be desired in order to provide a final composition having desired properties, as, e.g., a braze powder. When a non-HDH metal is present, the starting material preferably comprises a minor part of non-HDH metal. By “minor part of non-HDH metal” is meant that the composition comprises sufficient non-HDH metal to confer suitable properties to the composition (e.g., good brazing properties), and less than an amount that would render the composition unsuitable for HDH processing. Preferably, non-HDH metal comprises 5 mol %, 8 mol %, 10 mol %, 11 mol %, 12 mol %, 13 mol %, 14 mol %, 15 mol %, 20 mol %, 30 mol %, 40 mol % or 45 mol % of the starting material, and/or of the braze powder, as well as ranges formed by any two of these percentages, and all ranges subsumed within any of these ranges.

The starting material can also comprise one or more metalloid and/or non-metal if desired.

Table 1 provides a list of alloys amenable to the HDH process, and includes alloys that can be used in the present invention:

TABLE 1

| | nominal weight % | | | | | | | | | | | | HDH metals | | temps (° C.) | |
|---|---|---|---|---|---|---|---|---|---|---|---|---|---|---|---|---|
| alloy | Ti | Zr | V | Nb | Cu | Ni | Al | W | Sn | Mo | Cr | Fe | wt % | mol % | solidus | liquidus |
| BTi-1 | 70 | | | | 15 | 15 | | | | | | | 70 | 74.8 | 910 | 960 |
| BTi-2 | 60 | | | | 15 | 25 | | | | | | | 60 | 65.4 | 890 | 940 |
| BTi-3 | 37.5 | 37.5 | | | 15 | 10 | | | | | | | 75 | 74.6 | 839 | 843 |
| BTi-4 | 44 | 24 | | | 16 | 16 | | | | | | | 68 | 69.3 | | |
| BTi-5 | 40 | 20 | | | 20 | 20 | | | | | | | 60 | 61.7 | 848 | 856 |
| Ti-17 | 83 | 2 | | | | | 5 | | 2 | 4 | 4 | | 85 | 84.6 | | |
| Ti-21S | 79 | | | 3 | | | 3 | | | 15 | | | 82 | 86.3 | | |
| Ti-6246 | 82 | 4 | | | | | 6 | | 2 | 6 | | | 86 | 85.3 | | |
| Ti-1023 | 85 | | 10 | | | | 3 | | | | | 2 | 95 | 93.1 | | |
| Ti-15333 | 76 | | 15 | | | | 3 | | 3 | | 3 | | 91 | 90.6 | | |
| Ti64 | 90 | | 4 | | | | 6 | | | | | | 94 | 89.8 | 1604 | 1660 |
| Nb-20W- | | 1 | | 79 | | | | 20 | | | | | 80 | 88.8 | | |
| 1Zr | | | | | | | | | | | | | | | | |
| Ti Beta C | 75 | 4 | 8 | | | | 3 | | | 4 | 6 | | 87 | 86.8 | | |
| Ti₃Al* | 84.2 | | | | | | 15.8 | | | | | | 84.2 | 75 | | |
| Zr50-Ti26- | 17 | 63 | | | | 20 | | | | | | | 80 | 76 | 798 | 798 |
| 24Ni* | | | | | | | | | | | | | | | | |
| Zr52-Ti25- | 14 | 66 | | | 8 | 12 | | | | | | | 80 | 77 | 773 | 773 |
| 15Ni-8Cu* | | | | | | | | | | | | | | | | |
| Ti60-Zr15- | 50 | 24 | | | | 25 | | | | | | | 74 | 75 | 841 | 841 |
| Ni25** | | | | | | | | | | | | | | | | |
| Ti60-Zr15- | 50 | 24 | | | 9 | 17 | | | | | | | 74 | 75 | 831 | 831 |
| Ni-17- | | | | | | | | | | | | | | | | |
| Cu8** | | | | | | | | | | | | | | | | |

*The expressions Ti₃Al, Zr50-Ti26-Ni24, and Zr52-Ti25-Nil5-Cu8 represent nominal mol % (or atom %). The mass percentages for Zr-25Ti-15Ni-8Cu do not add to 100 due to rounding.
**US 2018/0133849 Al.

As is understood in the art, the nominal compositions may not represent exact proportions for any given sample. From sample to sample, proportions can vary within standard accepted limits from the nominal values.

Alloys amenable to the HDH process are preferred for use in the present invention. Some preferred alloys contemplated for use in the present invention include BTi-1, Ti-17, Ti-6246, Ti-215, Ti Beta C, Ti-15333, Ti-1023, Ti₃Al, Zr-26Ti-24Ni, and Zr-25Ti-15Ni-8Cu.

Alloys not amenable to the HDH process are not recommended for use in the present invention. Some alloys not recommended for use in the present invention include TiAl₃, TiAl, and Ti-48Al-2Cr-2Nb (mol %).

The starting materials are preferably alloys that substantially comprise HDH metal, non-HDH metal, optionally non-metal, and can also comprise trace impurities. The nominal compositions do not expressly list trace impurities. As a general matter, a trace impurity can comprise a metal or a non-metal. Metallic trace impurities can comprise any metal other than one listed in the nominal composition, such as trace amounts of Fe or Al in a sample of BTi-1. Non-metallic trace impurities can comprise any non-metallic substance, such as B, Si, C, H, N, or O. By “trace amount” is meant an amount of each impurity, and/or total impurities, that is not outside of the specification for a particular alloy. Alternatively, trace amount can mean less than 0.2 wt %, 0.1 wt %, or 0.05 wt % of a given impurity, or less than a total of 0.5 wt %, 0.2 wt %, 0.1 wt %, or 0.05 wt % of all impurities. Specifications for metallic and non-metallic impurities are known in the art for various alloy grades.

The material will generally be sized one or two times during the manufacturing process: the hydride may be sized after milling and before de-hydriding, and/or the alloy may be sized after de-hydriding and de-agglomerating. Preferably, both sizing stages are employed. When both sizing stages are employed, the target PSDs may be the same or different, and preferably are the same. The purpose of sizing is to obtain to a reasonable degree particles within a target PSD. Any suitable method may be used to size particles, with screening being a preferred method.

Screening typically involves use of two screens having differing mesh/micron size. Particles that pass through the coarser mesh but are captured on the finer mesh are retained, while larger particles that do not pass through the coarse screen, and finer particles that pass through the fine screen may be set aside for, e.g., discarding, recycling, or other purpose. As is known in the industry, an expression such as −n+m refers to a material having a particle size distribution less than n and larger than m. Thus, −106+45 μm refers to a fraction of material collected between two screens having respective apertures of 106 μm and 45 μm. Any desired PSD can be obtained, and PSD can be defined in terms of aperture size (e.g., μm), or in terms of mesh sizes (e.g., standard mesh sizes).

Some suitable aperture sizes for screening include 210 μm, 177 μm, 149 μm, 125 μm, 106 μm, 88, 74, 63 μm, 53 μm, 45 μm and 27 μm. Some suitable mesh sizes for screening include 70, 80, 90, 100, 120, 125, 140, 170, 200, 230, 250, 270, 325 and 400. As is known in the art, other aperture sizes and mesh sizes are available or can be manufactured. Standard screens, such as those listed in American Standard Sieve Series ASTM E11:01, British Standard Sieve Series BS.410:2000, and International Test Sieve Series ISO 3310:2000, may be used, and are incorporated herein by reference in their entireties. Some suitable PSDs are formed by combinations of any two screen sizes.

Certain HDH metals, such as titanium, zirconium, hafnium, vanadium, niobium, yttrium, and tantalum, have affinity for molecular oxygen, which can lead to presence of interstitial oxygen in the brazing powder. It has been unexpectedly found that lower levels of interstitial oxygen improve performance, such as better wetting and better fillet formation, compared to similar powders with higher levels of interstitial oxygen. Brazing powders that are produced by the HDH process, and comprise such metals, are found to comprise 0.26 wt % or higher of interstitial oxygen. Accordingly, it has been found advantageous to de-oxidize the brazing composition subsequent to the HDH process to decrease the amount of interstitial oxygen. The amount of interstitial oxygen is preferably less than or equal to 0.25 wt %, 0.20 wt %, or 0.15 wt %. While there is no preferred lower limit for interstitial oxygen, as a practical matter, the amount will be generally be greater than or equal to 0 wt %, 0.05 wt %, or 0.1 wt %.

The powder produced by the HDH process comprises particles that are angular (also referred to as angular-blocky or irregular shaped) and not spherical. Spherical titanium powders can be used in additive manufacturing methods, and can be subject to export controls. Irregular shaped titanium powders, however, are not suitable for additive manufacturing, are not subject to export controls, hence are more amenable to international commerce.

For better processing and flow properties, angular powder formed by the present process can optionally be spheroidized. There are several known methods for spheroidization. One such method that can be used is plasma spheroidization, which involves directing powders through a plasma jet, with the high plasma heat acting to melt and spheroidize the particles, and the plasma stream acting to prevent agglomeration or sintering of particles. Some spheroidization methods are disclosed in U.S. Pat. Nos. 7,671,294 and 4,246,208. After spheroidization, the product is optionally de-agglomerated and/or optionally sized.

As a general matter, brazing is done at a certain temperature difference (e.g., 50° C.) above the liquidus of the brazing alloy, but preferably below the solidus of the substrate alloy, as this avoids melting the substrate. The higher the temperature difference, the more likely it is that unwanted microstructural effects—such as grain growth, precipitation coarsening, and/or recrystallization—will form in the substrate. Thus, ability to braze at a lower temperature is advantageous.

A surprising and unexpected outcome is that the present process maintains homogeneity of the alloy to a high degree. That is, there is surprisingly little change in component distribution when the HDH'ed material, e.g., braze material, is analyzed on different scales, e.g., at 500 μm, at 100 μm, and at 25 μm. Information on content at various scales can be obtained by any suitable method, including energy-dispersive X-ray spectroscopy (EDS).

### EXAMPLES

### Example 1—BTi-1 Powder

A sample of BTi-1 (nominal formula Ti-15Ni-15Cu by weight) is obtained and analyzed for content using inductively coupled plasma mass spectrometry (ICP). The assay results are shown in Table 2:

TABLE 2

| | Spec. | ICP |
|---|---|---|
| Element | (wt %) | (wt %) |
| Ti | Balance | Balance |
| Ni | 14.0-16.0 | 15.3 |
| Cu | 14.0-16.0 | 15.0 |
| Fe | max 0.1 | 0.06 |
| Al | max 0.05 | <0.01 |
| Si | max 0.02 | <0.01 |
| C | 0.04 | <0.02 |
| H | N/A | 0.007 |
| N | 0.02 | <0.01 |
| O | 0.15 | 0.33 |
| TAO* | max 0.30 | <0.1 |

*TAO: total of all other impurities

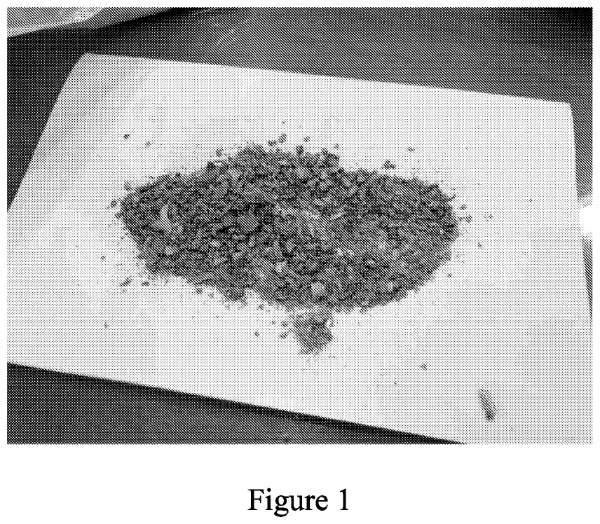

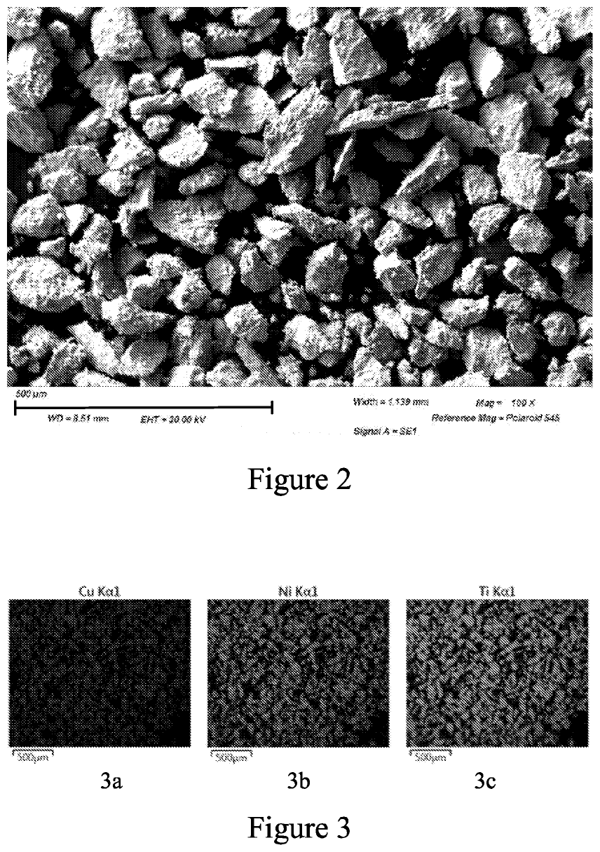

The sample is obtained in the form of a casting. The sample is placed into a furnace at a temperature in excess of 650° C. under a hydrogen atmosphere and slowly cooled at a rate sufficient to form the brittle hydride, then coarsely crushed, as shown in FIG. 1. The crushed hydride is pulverized in mill into a powder, and screened to obtain the target −106+45 μm fraction (e.g., per ASTM El 1), which is retained for further processing. The sized powder is then placed into a vacuum furnace at greater than 350° C. for sufficient time to de-hydride the sample. The sample is cooled, de-agglomerated and re-milled to separate the powder, then re-screened to provide a −106+45 μm titanium alloy powder. A photomicrograph of the product, Powder Al, is shown in FIG. 2.

The sample is analyzed using scanning electron microscopy in combination with energy-dispersive X-ray spectroscopy (SEM-EDS). A broad elemental map of the powder is shown in FIG. 3, with Cu shown in FIG. 3a, Ni in FIG. 3b, and Ti in FIG. 3c. The Ti, Ni, and Cu, appear well homogenized, and the EDS assay is Ti 73.1 wt %, Ni 14.0 wt %, and Cu 12.9 wt %.

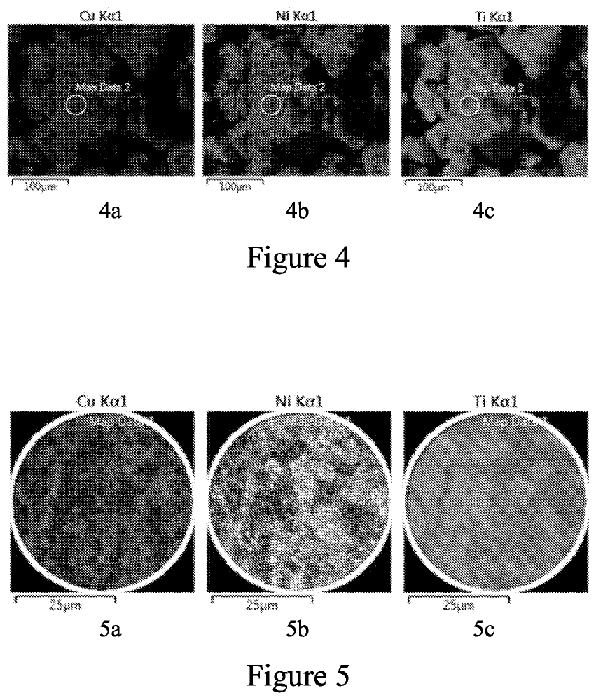

A single selected particle is also analyzed using SEM-EDS, as shown in FIG. 4, which shows that also on the particle level, the Ti, Ni, and Cu, appear well homogenized. The EDS assay is Ti 72.8 wt %, Ni 13.9 wt %, and Cu 13.3 wt %.

A small area of one particle is further analyzed using SEM-EDS as shown in FIG. 5, which also shows that Ti, Ni, and Cu are homogenized well within a particle. The EDS assay is Ti 74.7 wt %, Ni 13.4 wt %, and Cu 11.8 wt %. Areas somewhat rich in Cu (FIG. 5a), Ni (FIG. 5b), and Ti (FIG. 5c) are seen at this scale. But this considering the equilibrium phases (Ti, Ti₂Ni, Ti—Cu) of Ti-15Cu-15Ni, this is acceptable on this scale.

### Example 2— Brazing Ti-6Al-4V Coupons with BTi-1 Powder

Base coupons of Ti-6Al-4V are brazed with Powder Al, and are compared with results of base coupons brazed with a BTi-1 braze composition (AE12046, manufactured by ECOFM Co., Ltd. based on the specifications in in Table 2) manufactured using gas atomization (Powder C).

For each run, two rectangular coupons are used. One is horizontal, and the other is vertical. The two coupons are aligned with coinciding edges. A 0.5 g of brazing powder is piled approximately in the middle of the horizontal coupon. Another 0.5 g portion of brazing powder is placed along the common edge.

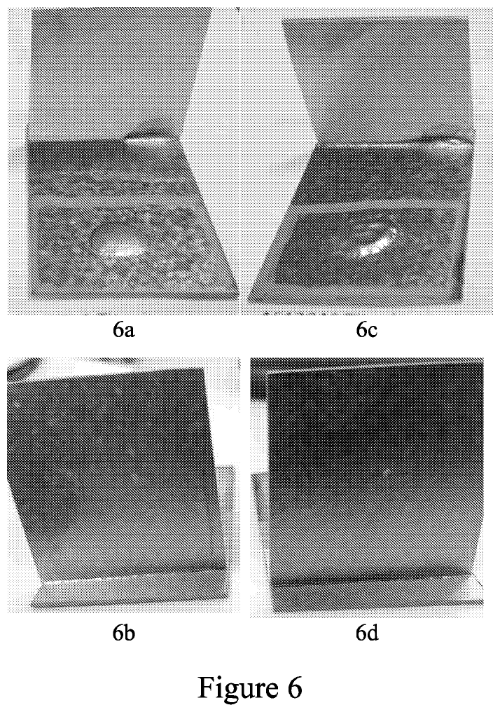

The coupons so prepared are placed in a furnace at 1050° C. for ten minutes. Photographs of the resulting brazed coupons are shown in FIG. 6. FIGS. 6a and 6b are front and back views of the coupons brazed with Powder Al. FIGS. 6c and 6d are front and back views of the coupons brazed with Powder C. The fillet formation appears comparable among the two sets of coupons.

### Example 3—Effect of Interstitial Oxygen on Brazing With HDH Powders

A sample of Powder Al of Example 2 determined to have 0.27% interstitial oxygen. Powder B is prepared by de-oxidizing a portion of Powder Al, and is determined to have 0.12% interstitial oxygen.

Base coupons of Ti-6Al-4V are brazed with Powders Al and B. For each run, two rectangular coupons are used in the manner described in Example 2, using a 0.5 g portion of brazing powder piled approximately in the middle of the horizontal coupon, and another 0.5 g portion of brazing powder placed along the common edge.

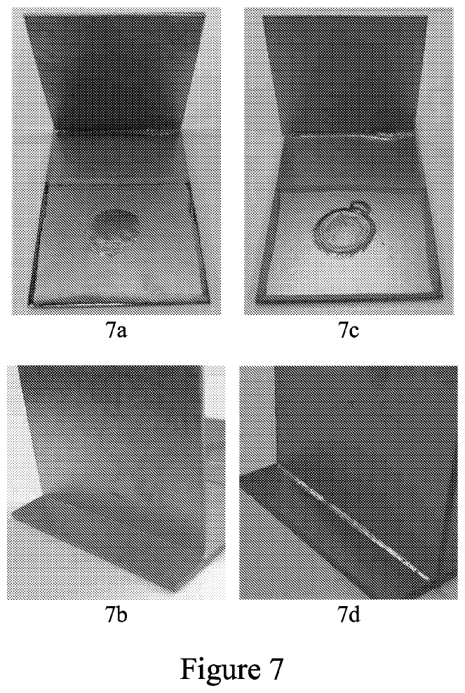

The coupons so prepared are placed in a furnace at 1000° C. for ten minutes. Photographs of the resulting brazed coupons are shown in FIG. 7. FIGS. 7a and 7b are front and back views of the coupons brazed with Powder A1. FIGS. 7c and 7d are front and back views of the coupons brazed with Powder B. The coupons brazed with the de-oxidized brazing powder exhibit better fillet formation and wetting than the coupons brazed with the brazing powder having higher content of interstitial oxygen.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The foregoing examples are provided merely for explanation, and are not to be construed as limiting the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims, as presently stated and as amended.

What is claimed:

1. A method for manufacturing a braze powder comprising:
obtaining a starting material amenable to HDH process, wherein the starting material is an alloy substantially comprising 55 mol % to 95 mol % HDH metal, and 5 mol % to 45 mol % non-HDH metal;
processing the starting material in an HDH process to obtain a processed HDH powder; and
sizing the HDH powder to obtain a target particle size distribution to obtain a sized HDH powder;
wherein the sized HDH powder is suitable for use as a braze powder.

2. The method of claim 1 wherein the HDH process comprises:
heating the starting material under suitable hydriding conditions to form a hydride-rich material;
pulverizing the hydride-rich material;
sizing the hydride-rich material to obtain a sized hydride having a target particle size distribution; and
heating the sized hydride under suitable dehydriding conditions to decompose metal hydride in the sized hydride to obtain the HDH powder.

3. The method of claim 1 further comprising sizing the de-hydrided powder to obtain a de-hydrided powder having a second target particle size distribution.

4. The method of claim 1 further comprising spheroidization of the sized HDH powder.

5. The method of claim 1 wherein the starting material comprises 75 mol % to 95 mol % HDH metal.

6. The method of claim 1 wherein the HDH metal comprises Ti, Zr, Hf, V, Nb, Ta, or a combination of two or more thereof.

7. The method of claim 1 wherein the HDH metal consists essentially of Ti, Zr, Hf, V, Nb, Ta, or a combination of two or more thereof.

8. The method of claim 1 wherein the non-HDH metal comprises Cu, Ni, W, Sn, Al, Zn, Mo, Cr, Fe, or a combination of two or more thereof.

9. A method for manufacturing a metal powder comprising:
obtaining a starting material amenable to HDH process, wherein the starting material is an alloy substantially comprising 55 mol % to 88 mol % HDH metal, and 12 mol % to 45 mol % non-HDH metal;
processing the starting material in an HDH process to obtain a processed HDH powder; and
sizing the HDH powder to obtain a target particle size distribution to obtain a sized HDH powder.

10. A braze powder prepared by:
obtaining a starting material, wherein the starting material is an alloy substantially comprising 55 mol % to 95 mol % HDH metal, and 5 mol % to 45 mol % non-HDH metal;
processing the starting material in an HDH process to obtain a processed HDH powder; and
sizing the HDH powder to obtain a target particle size distribution to obtain a sized HDH powder;
wherein the sized HDH powder is suitable for use as a braze powder.

11. The method of claim 1, which, after the processing of the starting material in the HDH process, further includes de-oxidizing to obtain an HDH powder having 0.25 wt % or less interstitial oxygen.

12. The method of claim 9, which, after the processing of the starting material in the HDH process, further includes de-oxidizing to obtain an HDH powder having 0.25 wt % or less interstitial oxygen.

13. The braze powder of claim 10, comprising 75 mol % to 95 mol % HDH metal.

14. The braze powder of claim 10 wherein the HDH metal comprises Ti, Zr, Hf, V, Nb, Ta, or a combination of two or more thereof.

15. The braze powder of claim 14 wherein the non-HDH metal comprises Cu, Ni, W, Sn, Al, Zn, Mo, Cr, Fe, or a combination of two or more thereof.

16. The braze powder of claim 10 wherein the HDH metal consists essentially of Ti, Zr, Hf, V, Nb, Ta, or a combination of two or more thereof.

17. The braze powder of claim 10 wherein the non-HDH metal comprises Cu, Ni, W, Sn, Al, Zn, Mo, Cr, Fe, or a combination of two or more thereof.

18. The braze powder of claim 10, wherein the starting material has a nominal composition of BTi-1 (Ti-15Ni-15Cu); BTi-2 (Ti-25Ni-15Cu); BTi-3 (Ti-37.5Zr-10Ni-15Cu); BTi-4 (Ti-24Zr-16Ni-16Cu); BTi-5 (Ti-20Zr-20Ni-20Cu); Ti-17 (Ti-2Zr-5Al-2Sn-4Mo-4Cr); Ti-21S (Ti-3Nb-3Al-15Mo); Ti-6246 (Ti-4Zr-6Al-2Sn-6Mo); Ti-1023 (Ti-10V-3Al-2Fe); Ti-15333 (Ti-15V-3Al-35n-3Cr); Ti64 (Ti-4V-6Al); Nb-20W-1Zr; Ti Beta C (Ti-4Zr-8V-3Al-4Mo-6Cr); Ti3Al; Zr-17Ti-20Ni; Zr-14Ti-12Ni-8Cu; Ti-24Zr-25Ni; or Ti-24Zr-17Ni-9Cu.

19. The braze powder of claim 10 comprising 0.25 wt % or less interstitial oxygen.

20. The braze powder of claim 18 comprising 0.25 wt % or less interstitial oxygen.
